(19) United States
(12) Patent Application Publication
(10) Pub. No.: US 2024/0240858 A1
(43) Pub. Date: Jul. 18, 2024

(54) DRYING DEVICE

(71) Applicant: NGK INSULATORS, LTD., Nagoya-Shi (JP)

(72) Inventors: Takuya MATSUMOTO, Nagoya-Shi (JP); Michirou AOKI, Obu-Shi (JP)

(73) Assignee: NGK INSULATORS, LTD., Nagoya-Shi (JP)

(21) Appl. No.: 18/410,122

(22) Filed: Jan. 11, 2024

(30) Foreign Application Priority Data
Jan. 13, 2023 (JP) 2023-003843

(51) Int. Cl. F26B 3/347; F26B 13/10; F26B 25/10

(52) U.S. Cl. CPC F26B 3/347; F26B 13/10; F26B 25/10

(57) ABSTRACT

A drying device may include: a body defining a drying space therein; a heater disposed in the drying space to face a surface of the film moving in the drying space, including an inner tube and an outer tube, and configured to radiate electromagnetic waves through the outer tube, wherein a surface temperature of the outer tube is maintained at 200 degrees or less; and a reflector at least partially covering the heater and configured to reflect at least a part of the electromagnetic waves radiated from the outer tube of the heater toward the film moving in the drying space. The heater may be configured to radiate electromagnetic waves in a wavelength band below a predetermined wavelength to the film and is configured to absorb electromagnetic waves in a wavelength band equal to or above the predetermined wavelength.

### REFERENCE TO RELATED APPLICATIONS

This application claims priority to Japanese Patent Application No. 2023-003843, filed on Jan. 13, 2023, the entire contents of which are hereby incorporated by reference into the present application.

### TECHNICAL FIELD

The disclosure herewith relates to a drying device configured to dry a film including a solvent.

### BACKGROUND ART

Japanese Patent No. 5842220 describes a drying device. This drying device includes a body that defines a drying space therein in which a film moves, and a heater that heats the film by radiating infrared rays in a wavelength band below a predetermined wavelength in the drying space.

### DESCRIPTION

In the drying device of Japanese Patent No. 5842220, a part of the infrared rays radiated from the heater reaches the film but the rest thereof reaches furnace walls of the body, etc. Therefore, it is necessary to set the output of the heater higher, taking into account the amount of infrared rays reaching the furnace walls, etc.

The disclosure herein provides a technology that allows for a reduction in the output of a heater.

In a first embodiment of the technology disclosed herein, a drying device may be configured to dry a film including a solvent. The drying device may comprise: a body comprising an entrance and an exit, wherein the body defines a drying space therein and the film moves from the entrance toward the exit in the drying space; a heater disposed in the drying space to face a surface of the film moving in the drying space, comprising an inner tube and an outer tube, and configured to radiate electromagnetic waves through the outer tube, wherein a surface temperature of the outer tube is maintained at 200 degrees or less by a fluid flowing between the inner tube and the outer tube; and a reflector at least partially covering the heater and configured to reflect at least a part of the electromagnetic waves radiated from the outer tube of the heater toward the film moving in the drying space. The heater may be configured to radiate electromagnetic waves in a wavelength band below a predetermined wavelength to the film and be configured to absorb electromagnetic waves in a wavelength band equal to or above the predetermined wavelength.

According to the above configuration, a part of the electromagnetic waves radiated from the heater reaches the film without being reflected by the reflector, and the other part of the electromagnetic waves radiated from the heater also reaches the film by being reflected by the reflector. Therefore, the electromagnetic waves radiated from the heater can reach the film more efficiently as compared to a configuration in which the drying device does not comprise the reflector. This allows for a reduction in the output of the heater.

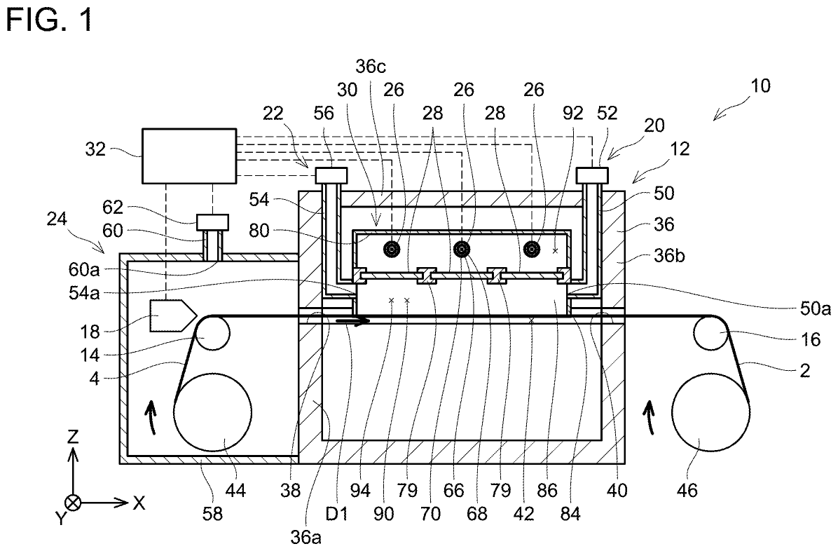

FIG. 1 shows a schematic cross-sectional view of a drying device according to a first embodiment.

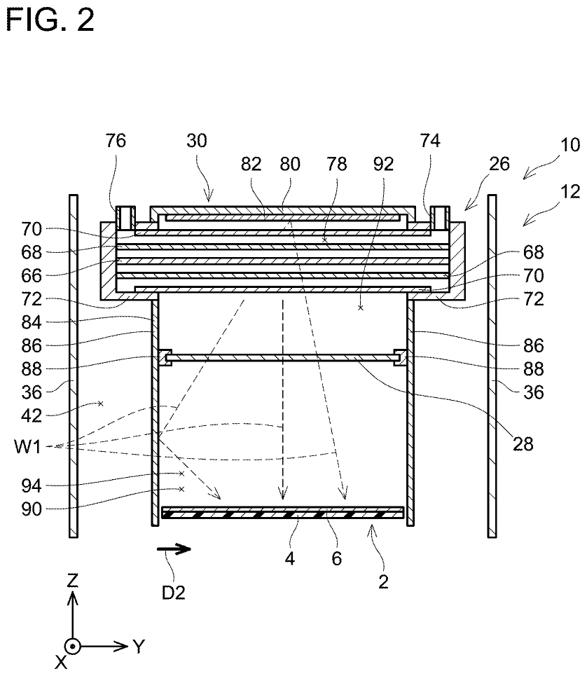

FIG. 2 shows a schematic cross-sectional view of the drying device according to the first embodiment.

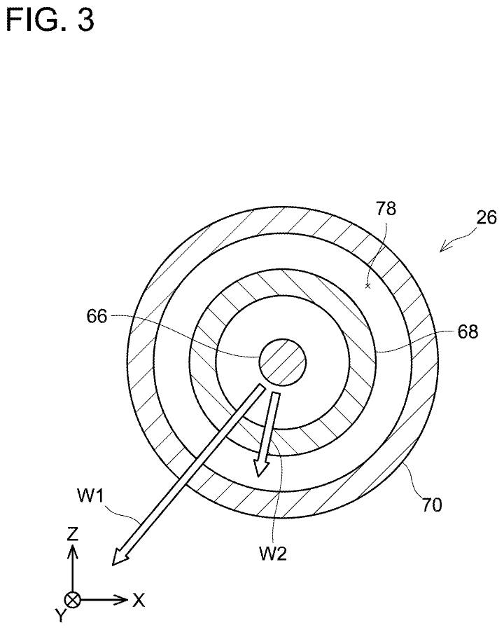

FIG. 3 shows a cross-sectional view of a heater according to the first embodiment.

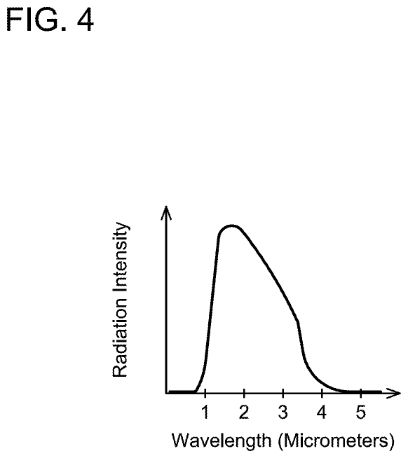

FIG. 4 shows a relationship between wavelength of electromagnetic waves radiated from the heater according to the first embodiment and radiation intensity.

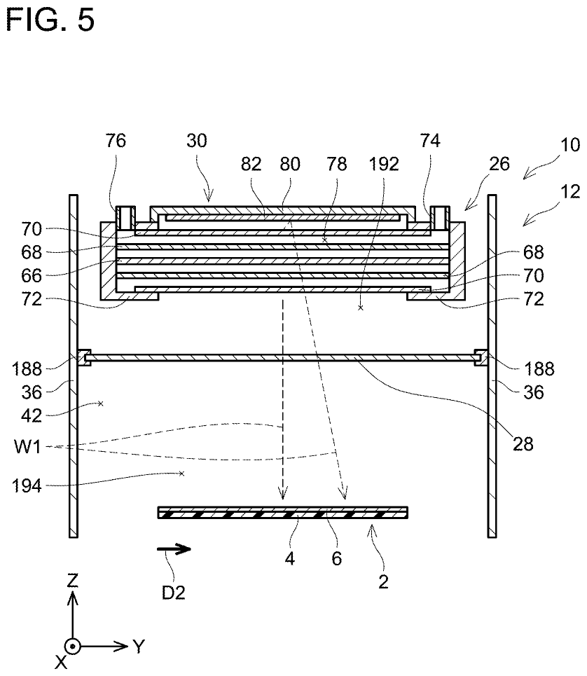

FIG. 5 shows a schematic cross-sectional view of a drying device according to a second embodiment.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved drying devices, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a second embodiment of the technology disclosed herein according to the first embodiment, the reflector may comprise a first reflective portion disposed opposite to the film moving in the drying space with the heater interposed therebetween. In this configuration, electromagnetic waves radiated from the heater in a direction opposite to a direction from the heater to the film are reflected by the reflector and can reach the film. Therefore, the electromagnetic waves radiated from the heater can efficiently reach the film. This allows for a further reduction in the output of the heater.

In a third embodiment of the technology disclosed herein according to the second embodiment, the reflector may further comprise a metal coating layer on a surface of the first reflective portion that faces the heater. A reflectance of the metal coating layer for the electromagnetic waves may be higher than a reflectance of the first reflective portion for the electromagnetic waves. According to the above configuration, the reflectance for the electromagnetic waves can be easily varied as compared to a configuration in which the first reflective portion and the metal coating layer are constituted of the same material.

In a fourth embodiment of the technology disclosed herein according to the second or third embodiment, the reflector may comprise two side reflective portions defining a passing space in which the electromagnetic waves pass between the heater and the surface of the film moving in the drying space, wherein the two side reflective portions are spaced from each other in a width direction of the film perpendicular to a moving direction of the film. The film may be positioned between the two side reflective portions in the width direction of the film. Even when electromagnetic waves are radiated from the heater to the film-side space, a part of the electromagnetic waves may not reach the film. In the above configuration, the part of the electromagnetic waves radiated from the heater to the film-side space can reach the film by being reflected by the reflector. Therefore, the electromagnetic waves radiated from the heater can be efficiently reach the film. This allows for a further reduction in the output of the heater.

In a fifth embodiment of the technology disclosed herein according to the fourth embodiment, the drying device may further comprise a partition configured to allow the electromagnetic waves to penetrate therethrough and disposed in the passing space. The partition may partition the passing space into a heater-side space defined between the heater and the partition and a film-side space defined between the film and the partition. This configuration suppresses the solvent evaporated from the film from coming into contact with the heater.

In a sixth embodiment of the technology disclosed herein according to any one of the first to fifth embodiments, a reflectance of the reflector for the electromagnetic waves may be equal to or more than 0.7. This configuration reduces electromagnetic waves to be absorbed by the reflector. This allows for a further reduction in the output of the heater.

In a seventh embodiment of the technology disclosed herein according to the sixth embodiment, the reflectance of the reflector for the electromagnetic waves may be equal to or more than 0.9. This configuration further reduces electromagnetic waves to be absorbed by the reflector. This allows for a further reduction in the output of the heater.

In an eighth embodiment of the technology disclosed herein according to any one of the first to seventh embodiments, the heater may be configured to radiate electromagnetic waves in a wavelength band below 4.0 micrometers and be configured to absorb electromagnetic waves in a wavelength band equal to or above 4.0 micrometers. The solvent contained in the film absorbs electromagnetic waves, and the solvent's absorption band for electromagnetic waves is around 3 micrometers. In the above configuration, the electromagnetic waves radiated from the heater are absorbed by the solvent. This allows the solvent to be efficiently dried.

In a ninth embodiment of the technology disclosed herein according to the eighth embodiment, 80% or more of the electromagnetic waves radiated by the heater may be electromagnetic waves in the wavelength band below 4.0 micrometers. In this configuration, the electromagnetic waves radiated from the heater are further absorbed by the solvent. This allows the solvent to be dried more efficiently.

In a tenth embodiment of the technology disclosed herein according to the eighth or ninth embodiment, a radiation intensity of the electromagnetic waves radiated from the heater may be maximized at a reference wavelength below 4.0 micrometers. A radiation intensity of electromagnetic waves of 4.0 micrometers may be less than 10% of a radiation intensity of electromagnetic waves of the reference wavelength. In this configuration, the electromagnetic waves radiated from the heater are further absorbed by the solvent. This allows the solvent to be dried more efficiently.

### First Embodiment

A drying device 10 according to a first embodiment shown in FIG. 1 is a roll-to-roll drying device. The drying device 10 dries a film 2 using electromagnetic waves. The film 2 includes a resin film body 4 and a coating 6. The resin film body 4 is constituted of for example polyethylene, polypropylene, or polyethylene terephthalate. As shown in FIG. 2, the coating 6 is disposed on a surface of the resin film body 4. The coating 6 includes an active material and a solvent. The active material is for example ceramics, polyimide, fluororesin, aramid fibers, carbon, lithium, cobalt, nickel, manganese, iron phosphate, or aromatic polyamide. The solvent is for example an organic solvent or a water solvent. The solvent absorbs electromagnetic waves in a wavelength band equal to or below 3.5 micrometers (e.g., in a wavelength band of 1.5 to 3.5 micrometers). For example, water solvents absorb electromagnetic waves in a wavelength band around 1.5 micrometers and in a wavelength band around 2.9 to 3.1 micrometers. In addition, organic solvents such as isopropanol, terpineol, N-methyl-2-pyrrolidone, and toluene, absorb electromagnetic waves in a wavelength band around 3.3 micrometers, and isopropanol and terpineol further absorb electromagnetic waves in a wavelength band around 2.9 to 3.1 micrometers. The solvent evaporates by absorbing electromagnetic waves from the drying device 10. The dried film 2 is used for example in a lithium-ion battery.

As shown in FIG. 1, the drying device 10 comprises a body 12, a first roller 14, a second roller 16, a coating device 18, a gas supply device 20, a first gas suction device 22, a second gas suction device 24, a plurality of heaters 26, a plurality of partitions 28, a reflector 30, and a control unit 32. The control unit 32 controls the first roller 14, the second roller 16, the coating device 18, the gas supply device 20, the first gas suction device 22, the second gas suction device 24, and the heaters 26.

The body 12 comprises a wall unit 36, an entrance 38, and an exit 40. The wall unit 36 is a substantially cuboid-shaped heat insulating structure having a longitudinal direction along X-direction. The wall unit 36 defines a drying space 42 therein. The entrance 38 is formed in a first side wall 36a of the wall unit 36. The exit 40 is formed in a second side wall 36b of the wall unit 36. The second side wall 36b is located opposite to the first side wall 36a. The drying space 42 is in communication with the space outside the body 12 through the entrance 38 and the exit 40.

The first roller 14 and the coating device 18 are located outside the body 12 and near the entrance 38. The coating device 18 is configured to apply a coating solution including the active material and the solvent to a surface of the resin film body 4. The second roller 16 is located outside the body 12 and near the exit 40. When the first roller 14 and the second roller 16 rotate, the resin film body 4 is pulled out from a supply drum 44, and then the coating device 18 applies the coating solution onto the surface of the resin film body 4. Thus, the coating 6 (see FIG. 2) is applied onto the surface of the resin film body 4. After this, the resin film body 4 to which the coating 6 has been applied (i.e., the film 2) enters the drying space 42 through the entrance 38 and moves through the drying space 42 in +X direction (in a moving direction D1) from the entrance 38 to the exit 40. While the film 2 is moving through the drying space 42, the solvent in the coating 6 and moisture in the resin film body 4 evaporate and thus the film 2 is dried. After this, the film 2 exits the body 12 through the exit 40 and is reeled onto a wind-up drum 46.

The gas supply device 20 comprises a gas supply pipe 50 and a gas supply fan 52. The gas supply pipe 50 penetrates an upper wall 36c of the wall unit 36, and a gas supply port 50a of the gas supply pipe 50 is located near the exit 40. The gas supply fan 52 delivers ambient gas into the drying space 42 through the gas supply port 50a. The ambient gas is for example an inert gas (e.g., nitrogen gas).

The first gas suction device 22 comprises a first gas suction pipe 54 and a first gas suction fan 56. The first gas suction pipe 54 penetrates the upper wall 36c of the wall unit 36. A first gas suction port 54a of the first gas suction pipe 54 is located near the entrance 38. The first gas suction port 54a faces the gas supply port 50a. The first gas suction fan 56 draws gas in the drying space 42 into the first gas suction pipe 54 through the first gas suction port 54a. The gas in the drying space 42 contains for example the solvent and water vapor evaporated from the film 2, in addition to the ambient gas.

The second gas suction device 24 comprises a second wall unit 58, a second gas suction pipe 60, and a second gas suction fan 62. The first roller 14 and the coating device 18 are located inside the second wall unit 58. The second gas suction pipe 60 penetrates the second wall unit 58. The second gas suction fan 62 draws gas in the second wall unit 58 into the second gas suction pipe 60 through a second gas suction port 60a of the second gas suction pipe 60. The gas in the second wall unit 58 contains for example evaporated solvent.

The plurality of heaters 26 are arranged along X direction within the drying space 42. The heaters 26 face the surface of the film 2 moving in the drying space 42. As shown in FIGS. 2 and 3, the heaters 26 extend in Y direction which is substantially orthogonal to the moving direction D1 of the film 2. Each heater 26 comprises a heating element 66, an inner tube 68, an outer tube 70, two caps 72, a gas supply pipe 74, and a gas exhaust pipe 76. The heating element 66 is a filament. The heating element 66 is controlled by the control unit 32 (see FIG. 1) to generate heat. The heating temperature of the heating element 66 is in a range from 700 to 1500 degrees. The heating element 66 radiates electromagnetic waves such as infrared rays (or ultraviolet rays or visible light) by generating heat. The inner tube 68 has a substantially cylindrical shape. The inner tube 68 surrounds the outer surface of the heating element 66. The inner tube 68 is constituted of for example quartz glass or borosilicate glass. The outer tube 70 has a substantially cylindrical shape. The outer tube 70 surrounds the outer surface of the inner tube 68. The outer tube 70 is constituted of the same material as that of the inner tube 68. A fluid passage 78 is defined between the outer tube 70 and the inner tube 68. A cooling fluid flows in the fluid passage 78. The cooling fluid is for example air or an inert gas. One of the caps 72 is fitted to one end of the outer tube 70 and the other cap 72 is fitted to the other end of the outer tube 70. The heating element 66 and the inner tube 68 are located between the two caps 72. The heating element 66 and the inner tube 68 are enclosed by the outer tube 70 and the two caps 72. The gas supply pipe 74 is attached to one cap 72. The gas exhaust pipe 76 is attached to the other cap 72. The cooling fluid flows through the gas supply pipe 74, the fluid passage 78, and the gas exhaust pipe 76 in this order, which cools the inner tube 68 and the outer tube 70.

The inner tube 68 and the outer tube 70 each allow electromagnetic waves W1 in a wavelength band below 4.0 micrometers to penetrate therethrough (see FIG. 3) and absorb electromagnetic waves W2 in a wavelength band equal to or above 4.0 micrometers (see FIG. 3). Thus, each heater 26 radiates the electromagnetic waves W1 in the wavelength band below 4.0 micrometers and absorbs the electromagnetic waves W2 in the wavelength band equal to or above 4.0 micrometers. It should be noted that “absorb electromagnetic waves” herein means not only absorbing all of the electromagnetic waves but also absorbing a part of the electromagnetic waves. As shown in FIG. 4, a radiation intensity of the electromagnetic waves radiated from the heaters 26 is maximized at a reference wavelength. The reference wavelength is equal to or less than 3.0 micrometers, and in this embodiment, it is 1.8 micrometers. A radiation intensity of the electromagnetic waves at 4.0 micrometers is less than 10% of the radiation intensity of the electromagnetic waves at the reference wavelength. In addition, a radiation intensity of the electromagnetic waves at 3.5 micrometers is less than 20% of the radiation intensity of the electromagnetic waves at the reference wavelength. 80% or more, preferably 90% or more, more preferably 95% or more of the electromagnetic waves radiated from the heaters 26 is the electromagnetic waves W1 in the wavelength band below 4.0 micrometers. Further, 80% or more, preferably 85% or more, more preferably 90% or more of the electromagnetic waves radiated from the heaters 26 is electromagnetic waves in a wavelength band below 3.5 micrometers. Although the heaters 26, more specifically, the inner tubes 68 and the outer tubes 70 absorb the electromagnetic waves W2 in the wavelength band equal to or above 4.0 micrometers (or 3.5 micrometers), the temperature of surfaces of the heaters 26 (surfaces of the outer tubes 70) is maintained equal to or below 200 degrees, in this embodiment, equal to or below 150 degrees, because the cooling fluid flows through the fluid passage 78.

As shown in FIG. 1, the plurality of partitions 28 are located between the heaters 26 and the surface of the moving film 2. The partitions 28 are connected to each other via connection members 79. The partitions 28 are located closer to the heaters 26 than the gas supply port 50a of the gas supply pipe 50 and the first gas suction port 54a of the first gas suction pipe 54 are. Therefore, the ambient gas flows in from the gas supply port 50a of the gas supply pipe 50 can flow along surfaces of the partitions 28 to the first gas suction port 54a of the first gas suction pipe 54. The partitions 28 comprise for example muffles. The partitions 28 are configured to allow the electromagnetic waves radiated from the heaters 26 to penetrate therethrough. Therefore, the electromagnetic waves radiated from the heaters 26 pass through the partitions 28 and reach the moving film 2. Further, the partitions 28 are configured to prohibit any gas from penetrating therethrough. This prevents evaporated solvent and water vapor from the film 2 from passing through the partitions 28 and coming into contact with the heaters 26.

As shown in FIGS. 1 and 2, the reflector 30 has a plate shape having a longitudinal direction along X direction. As shown in FIG. 1, the reflector 30 partially covers each of the plurality of heaters 26 arranged in X direction in the drying space 42. The reflector 30 comprises a first reflective portion 80, a metal coating layer 82 (see FIG. 2), and a second reflective portion 84. The first reflective portion 80 has a plate shape that is substantially parallel to XY plane. The first reflective portion 80 partially covers the surfaces of the heaters 26 (surfaces of the outer tubes 70). The first reflective portion 80 is located between the heaters 26 and the upper wall 36c of the wall unit 36. The first reflective portion 80 is spaced apart from the heaters 26 and the upper wall 36c. As shown in FIG. 2, the first reflective portion 80 is located opposite to the moving film 2 with the heaters 26 interposed therebetween. The first reflective portion 80 is farther away from the moving film 2 than from the heaters 26. The heaters 26 are located between the first reflective portion 80 and the partitions 28.

The first reflective portion 80 is constituted of a metallic material such as aluminum or stainless steel. A surface of the first reflective portion 80 is buffed. Thus, the surface of the first reflective portion 80 is mirror finished. The surface roughness Ra of the first reflective portion 80 is less than 5 micrometers, preferably less than 1 micrometer, more preferably less than 0.1 micrometer. Here, the surface roughness Ra indicates an arithmetic mean roughness. The reflectance of the first reflective portion 80 for electromagnetic waves is 70% or more, preferably 90% or more. For example, the reflectance of the first reflective portion 80 is 85% or more for electromagnetic waves in the wavelength band equal to or above 3.5 micrometers, 82% or more for electromagnetic waves at 2.5 micrometers, 79% or more for electromagnetic waves at 1.5 micrometers, and 74% or more for electromagnetic waves at 0.5 micrometers. Further, for example, the reflectance of the first reflective portion 80 is 95% or more for electromagnetic waves in the wavelength band equal to or above 3.5 micrometers, 92% or more for electromagnetic waves at 2.5 micrometers, 91% or more for electromagnetic waves of 1.5 micrometers, and 90% or more for electromagnetic waves of 0.5 micrometers.

The metal coating layer 82 is partially disposed on the surface of the first reflective portion 80 and partially covers the surfaces of the outer tube 70. In a variant, the metal coating layer 82 may be disposed over the entire surface of the first reflective portion 80. The metal coating layer 82 is located opposite to the moving film 2 with the heaters 26 interposed therebetween. The metal coating layer 82 is located between the first reflective portion 80 and the surfaces of the outer tubes 70. The metal coating layer 82 faces the heaters 26. The metal coating layer 82 is constituted of a metallic material such as gold or platinum. The metal coating layer 82 is formed for example by a spray coating method in which a coating agent including the metallic material is sprayed onto the surface of the first reflective portion 80. The thickness of the metal coating layer 82 is less than the thickness of the first reflective portion 80. In FIGS. 2 and 5, the thickness of the metal coating layer 82 is illustrated in an exaggerated manner. The metal coating layer 82 is constituted of for example a different material than the material of the first reflective portion 80. The reflectance of the metal coating layer 82 for electromagnetic waves is greater than the reflectance of the first reflective portion 80 for electromagnetic waves. The reflectance of the metal coating layer 82 for electromagnetic waves is 95% or more, preferably 99% or more.

The second reflective portion 84 is integrally formed with the first reflective portion 80. The second reflective portion 84 is connected to the first reflective portion 80. The second reflective portion 84 surrounds the heaters 26 and the partitions 28. The second reflective portion 84 is spaced apart from the wall unit 36. As shown in FIG. 1, the second reflective portion 84 extends in the moving direction D1 of the film 2 (in X direction) from near the gas supply port 50a of the gas supply pipe 50 to near the first gas suction port 54a of the first gas suction pipe 54. As shown in FIG. 2, the second reflective portion 84 comprises two side reflective portions 86. The side reflective portions 86 are in contact with the caps 72 of the heaters 26. Thus, the side reflective portions 86 are not in contact with the outer tubes 70 of the heaters 26. The two side reflective portions 86 are located such that the film 2 is interposed therebetween in a width direction D2 of the film (in Y direction). The width direction D2 of the film 2 is substantially orthogonal to the moving direction D1 of the film 2. The film 2 is located between the two side reflective portions 86 in the width direction D2. Further, with respect to a direction that is substantially orthogonal to both the moving direction D1 and the width direction D2 (Z direction), the two side reflective portions 86 extend from the first reflective portion 80 in −Z direction beyond the film 2. The interval between the two side reflective portions 86 in Y direction is greater than the width of the film 2 (the length of the film 2 in Y direction). Therefore, there are clearances between the side reflective portions 86 and the film 2 in Y direction. This prevents the film 2 from contacting the side reflective portions 86 while moving.

The second reflective portion 84 defines a passing space 90 between the two side reflective portions 86 and between the heaters 26 and the moving film 2. In Y direction, the width of the passing space 90 is greater than the width of the film 2. Further, in Z direction, the passing space 90 overlaps the entire film 2. The second reflective portion 84 supports the partitions 28 between the two side reflective portions 86 via sealing members 88. The partitions 28 and the sealing members 88 are located in the passing space 90. The partitions 28 partition the passing space 90 into a heater-side space 92 and a film-side space 94. The sealing members 88 seal between the partitions 28 and the side reflective portions 86. Thus, the heater-side space 92 and the film-side space 94 are separate from each other in an airtight manner.

The heater-side space 92 is closer to the heaters 26 than the partitions 28 are and is defined between the heaters 26 and the partitions 28 in Z direction orthogonal to the moving direction D1 and the width direction D2 of the film 2. The film-side space 94 is closer to the film 2 than the partitions 28 are and is defined between the partitions 28 and the film 2. In the film-side space 94, the ambient gas flows from the gas supply port 50a of the gas supply pipe 50 toward the first gas suction port 54a of the first gas suction pipe 54.

The second reflective portion 84 is constituted of a metallic material such as aluminum or stainless steel. The second reflective portion 84 is constituted of the same material as that of the first reflective portion 80. A surface of the second reflective portion 84 is buffed. Thus, the surface of the second reflective portion 84 is mirror finished. The surface roughness Ra of the second reflective portion 84 is less than 5 micrometers, preferably less than 1 micrometer, more preferably less than 0.1 micrometer. The surface roughness Ra of the second reflective portion 84 is substantially equal to the surface roughness Ra of the first reflective portion 80. The reflectance of the second reflective portion 84 for electromagnetic waves is substantially equal to the reflectance of the first reflective portion 80 for electromagnetic waves.

Referring now to FIG. 2, how the film 2 is dried by electromagnetic waves (infrared rays) radiated from the heaters 26 is described. When the heating elements 66 generate heat, electromagnetic waves are radiated from the heating elements 66. The radiated electromagnetic waves pass through the inner tubes 68 and the outer tubes 70 into the heater-side space 92. The electromagnetic waves radiated from the heaters 26 are mainly electromagnetic waves W1 in the wavelength band below 4.0 micrometers. The electromagnetic waves radiated from the heaters 26 pass through the partitions 28 and the film-side space 94 and then reach the coating 6 of the film 2. A part of the electromagnetic waves that is radiated from the heaters 26 toward the film 2 (in downward direction on the drawing plane of FIG. 2) reaches the coating 6 of the film 2 after reflected by the second reflective portion 84 (e.g., the side reflective portions 86) or without being reflected by the second reflective portion 84. On the other hand, another part of the electromagnetic waves that is radiated from the heaters 26 in a direction away from the film 2 (in upward direction on the drawing plane of FIG. 2) is reflected by the metal coating layer 82 (or the first reflective portion 80) toward the film 2. Then, these electromagnetic waves reach the coating 6 of the film 2 after reflected by the second reflective portion 84 (e.g., the side reflective portions 86) or without being reflected by the second reflective portion 84. The use of the reflector 30 suppresses the electromagnetic waves from reaching the wall unit 36, so that the electromagnetic waves efficiently reach the film 2. This allows for a reduction in the output of the heaters 26 (power to the heating elements 66).

Once reaching the film 2, the electromagnetic waves are absorbed by the solvent in the coating 6. The electromagnetic waves also reach the resin film body 4 and are absorbed by the moisture in the resin film body 4. As a result, the solvent in the coating 6 and the moisture in the resin film body 4 evaporate, and the film 2 is dried. In addition, since the electromagnetic waves are absorbed by the solvent and moisture, the coating 6 and the resin film body 4 are less likely to be heated. Thus, the heating of the film 2 is suppressed and a decrease in the strength of the film 2 due to the drying is less likely to occur.

### Effects

The drying device 10 according to the present embodiment comprises the reflector 30 which reflects at least a part of the electromagnetic waves radiated through the outer tubes 70 of the heaters 26 toward the film 2 moving in the drying space 42. A part of the electromagnetic waves radiated from the heaters 26 reaches the film 2 without being reflected by the reflector 30, and another part thereof also reaches the film 2 by being reflected by the reflector 30. Therefore, the electromagnetic waves radiated from the heaters 26 can efficiently reach the film 2 as compared with a configuration where the drying device 10 does not comprise the reflector 30. This allows a reduction in the output of the heaters 26.

### Second Embodiment

Referring to FIG. 5, a second embodiment is described. For the second embodiment, only differences from the first embodiment are described. In the second embodiment, the reflector 30 does not comprise the second reflective portion 84 of the first embodiment. In the second embodiment, the partitions 28 are fixed to the wall unit 36 via sealing members 188. The partitions 28 partition the drying space 42 inside the wall unit 36 into a heater-side space 192 and a film-side space 194. The sealing members 188 seal between the partitions 28 and the wall unit 36. Thus, the heater-side space 192 and the film-side space 194 are separate in an airtight manner.

The heater-side space 192 is defined between the partitions 28 and the heaters 26. The film-side space 194 is defined between the partitions 28 and the moving film 2. In the film-side space 194, the ambient gas flows from the gas supply port 50a of the gas supply pipe 50 toward the first gas suction port 54a of the first gas suction pipe 54.

Next, how the film 2 is dried by electromagnetic waves radiated from the heaters 26 is described. Electromagnetic waves radiated from the heaters 26 into the heater-side space 192 pass through the partitions 28 and the film-side space 194 and then reach the coating 6 of the film 2. A part of the electromagnetic waves that is radiated from the heaters 26 toward the film 2 (in downward direction on the drawing plane of FIG. 5) directly reaches the coating 6 of the film 2. On the other hand, another part of the electromagnetic waves that is radiated from the heaters 26 in the direction away from the film 2 (in upward direction on the drawing plane of FIG. 5) is reflected by the metal coating layer 82 (or the first reflective portion 80) toward the film 2 and then reaches the coating 6 of film 2. Once reaching the film 2, the electromagnetic waves are absorbed by the solvent in the coating 6 and moisture in the resin film body 4. As a result, the solvent and the moisture evaporate, and the film 2 is dried.

### Variants

In one embodiment, the metal coating layer 82 may be disposed on a surface of the second reflective portion 84 as well. In the case where the metal coating layer 82 is disposed on the surface of the second reflective portion 84, the metal coating layer 82 may be disposed over the entire surface of the second reflective portion 84 or on a part of the surface of the second reflective portion 84.

In one embodiment, the reflector 30 may not comprise the metal coating layer 82.

In one embodiment, the second reflective portion 84 may not extend beyond the film 2, and may extend from the first reflective portion 80 to a position between the partitions 28 and the film 2. In this case, there are clearances between the second reflective portion 84 and the film 2 in Z direction.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A drying device configured to dry a film including a solvent, the drying device comprising:
a body comprising an entrance and an exit, wherein the body defines a drying space therein and the film moves from the entrance toward the exit in the drying space;
a heater disposed in the drying space to face a surface of the film moving in the drying space, comprising an inner tube and an outer tube, and configured to radiate electromagnetic waves through the outer tube, wherein a surface temperature of the outer tube is maintained at 200 degrees or less by a fluid flowing between the inner tube and the outer tube; and
a reflector at least partially covering the heater and configured to reflect at least a part of the electromagnetic waves radiated from the outer tube of the heater toward the film moving in the drying space,
wherein
the heater is configured to radiate electromagnetic waves in a wavelength band below a predetermined wavelength to the film and is configured to absorb electromagnetic waves in a wavelength band equal to or above the predetermined wavelength.

2. The drying device according to claim 1, wherein the reflector comprises a first reflective portion disposed opposite to the film moving in the drying space with the heater interposed therebetween.

3. The drying device according to claim 2, wherein
the reflector further comprises a metal coating layer on a surface of the first reflective portion that faces the heater, and
a reflectance of the metal coating layer for the electromagnetic waves is higher than a reflectance of the first reflective portion for the electromagnetic waves.

4. The drying device according to claim 2, wherein
the reflector comprises two side reflective portions defining a passing space in which the electromagnetic waves pass between the heater and the surface of the film moving in the drying space, wherein the two side reflective portions are spaced from each other in a width direction of the film perpendicular to a moving direction of the film, and
the film is positioned between the two side reflective portions in the width direction of the film.

5. The drying device according to claim 4, further comprising a partition configured to allow the electromagnetic waves to pass therethrough and disposed in the passing space,
wherein the partition partitions the passing space into a heater-side space defined between the heater and the partition and a film-side space defined between the film and the partition.

6. The drying device according to claim 1, wherein a reflectance of the reflector for the electromagnetic waves is equal or more than 0.7.

7. The drying device according to claim 6, wherein the reflectance of the reflector for the electromagnetic waves is equal or more than 0.9.

8. The drying device according to claim 1, wherein the heater is configured to radiate electromagnetic waves in a wavelength band below 4.0 micrometers and is configured to absorb electromagnetic waves in a wavelength band equal to or above 4.0 micrometers.

9. The drying device according to claim 8, wherein 80% or more of the electromagnetic waves radiated by the heater is electromagnetic waves in the wavelength band below 4.0 micrometers.

10. The drying device according to claim 8, wherein
a radiation intensity of the electromagnetic waves radiated from the heater is maximized at a reference wavelength below 4.0 micrometers, and
a radiation intensity of electromagnetic waves at 4.0 micrometers is less than 10% of a radiation intensity of electromagnetic waves at the reference wavelength.
